(19) United States
(12) Patent Application Publication
(10) Pub. No.: US 2022/0405869 A1
(43) Pub. Date: Dec. 22, 2022

(54) REAL ESTATE BUBBLE PREDICTION BASED ON BIG DATA

(71) Applicant: Newmark & Company Real Estate, Inc., New York, NY (US)

(72) Inventors: Marshall O'Moore, New York, NY (US); Maureen Welch, New York, NY (US); Roosevelt V. Segarra, New York, NY (US)

(21) Appl. No.: 17/893,291

(22) Filed: Aug. 23, 2022

Related U.S. Application Data
(63) Continuation of application No. 17/017,187, filed on Sep. 10, 2020.
Application No. 17/017,187 is a continuation of application No. 15/369,334, filed on Dec. 5, 2016, now abandoned.
(60) Provisional application No. 62/263,376, filed on Dec. 4, 2015.
(60) Provisional application No. 62/269,670, filed on Dec. 18, 2015.
(60) Provisional application No. 62/273,040, filed on Dec. 30, 2015.
(60) Provisional application No. 62/275,619, filed on Jan. 6, 2016.

(51) Int. Cl. G06Q 50/16; G06Q 30/02

(52) U.S. Cl. CPC G06Q 50/16; G06Q 30/0204

(57) ABSTRACT

Disclosed herein are a computer apparatus, non-transitory computer readable medium, and method for predicting real estate bubbles based on big data analysis. Historical variable data associated with real estate assets are obtained from remote data sources. Portions of the historical variable data are distributed among a plurality nodes. Historical real estate values are received from the plurality of nodes. A plurality of previous peaks in the historical real estate values are identified. A prediction of a future peak in real estate values is generated. An alert comprising the prediction is transmitted.

### CROSS REFERENCE TO RELATED APPLICATIONS

This application is a continuation of U.S. patent application Ser. No. 17/017,187 filed Sep. 10, 2020, which is a continuation of U.S. patent application Ser. No. 15/369,334 filed Dec. 5, 2016 which claims priority to U.S. Provisional Patent Application Ser. No. 62/263,376 filed on Dec. 4, 2015; U.S. Provisional Patent Application Ser. No. 62/269,670 filed on Dec. 18, 2015; U.S. Provisional Patent Application Ser. No. 62/273,040 filed on Dec. 30, 2015; and U.S. Provisional Patent Application Ser. No. 62/275,619 filed on Jan. 6, 2016, the content of which are incorporated herein by reference in their entireties.

### BACKGROUND

Since 1975, there have been five generally recognized commercial real estate (CRE) asset bubbles in the U.S. Bubbles may occur when the prices of securities or other assets rise so sharply and at such a sustained rate that they exceed valuations justified by fundamentals. Such a rise in asset prices make a sudden collapse in prices likely. Similar to natural disasters, the recovery after a dramatic downturn can be long and the cleanup can be arduous.

### BRIEF DESCRIPTION OF THE DRAWINGS

FIG. 1 is an example system in accordance with aspects of the present disclosure.

FIG. 2 is a flow diagram of an example method in accordance with aspects of the present disclosure.

FIG. 3 illustrates a working example of peak identification in accordance with aspects of the present disclosure.

FIG. 4 illustrates a further working example of peak identification in accordance with aspects of the present disclosure.

FIG. 5 illustrates a working example of calculating a time duration between peaks in accordance with aspects of the present disclosure.

FIG. 6 illustrates a working example of peak prediction in accordance with aspects of the present disclosure.

While commercial real estate has become mainstream, it is still a relatively illiquid “long lead time” asset. When the market prices change, it is difficult to quickly divest of or invest in commercial real estate assets because the assets are heterogeneous, and it takes considerable time to establish market value. Transaction closings are often reflective of values negotiated six months prior (accounting for time to conduct contract negotiations, conduct due diligence, and arrangement financing), causing a lag in value adjustments to market conditions. Further, commercial real estate lending relies upon appraisals to establish value comparisons. In a severe market correction, appraisers generally disregard closings from distressed sales in establishing current market values. Finding sufficient arms-length (i.e., not distressed) comparable market sales to support “corrected” values can often take two years or more to be reflected in area values. This time period is often characterized by lack of sales activity, with a considerable gap between the “bid” (what investors are willing to pay for properties) and the “ask” (the price at which sellers are willing to sell their properties). Sellers with insufficient cash flow or cash reserves waiting for their asking price to be met by market conditions can find themselves in distress, with a lender repossessing the asset or forcing a sale. In either case, the distressed value is not generally reflected in comparable arms-length sales that can be used to establish market value, thus enforcing a cycle of illiquidity and a very slow market recovery.

Taken together, the commercial real estate market illiquidity can result in asset bubbles. While the bubble formation can have very positive and far-reaching impacts on investors and cities (e.g., in terms of wealth creation, physical form of cities including both buildings and infrastructure, and general societal advancement), bubble “popping” and the resulting severe downturn can have longstanding and widespread negative impacts.

Metrics and analytical tools are maturing, but they continue to be imperfect for managing the commercial real estate (“CRE”) asset class. Compared to other asset classes, even the U.S. property market lacks some key historic data to support extremely advanced modeling and decision making. Capitalization rates (a.k.a. “cap rates”) may be described as the first-year yield on cost an investor would receive on an all cash purchase. Such cap rates may be recognized as the standard measure of yield for real estate and a key metric for comparing assets. However, the assumptions associated with the “cap rate” calculation are not always well documented, and do not account for varying lease terms, credit profiles, rent volatility, or other market conditions, which may logically influence investor behavior. Indexes have been introduced, but a predictive system that forecasts market movements and addresses both the illiquidity and unique risks associated with CRE is not readily available.

Business cycles and their accompanying peaks and downturns unfold over the course of several years. Any model that attempts to address distinguishing features of these cycles must do so over a suitably long time frame. This exercise requires a long run time series of commercial real estate values, which may be stored in vast data sets. As noted above, commercial cap rates may be the most relevant metric for this particular exercise, and are available from several sources, each with unique characteristics. Given the relative infrequency of commercial transactions, this data is subject to both noise and lag that cause the data to be unreliable. High quality commercial cap rates are available from various vendors, including Real Capital Analytics and Case-Schiller, but this data does not currently have enough history. Appraisal based cap rates are available with much more history and less noise but are subject to the biases inherent in appraisals.

Vast amounts of historical data may need to be digitally processed to produce a quality prediction of ebbs and flows in the real estate market. However, processing such massive data sets presents many technical challenges. Conventional big data processing techniques simply divide big datasets among different nodes in equally sized portions without accounting for the bandwidth or workload of each node. Accordingly, it would be desirable to have a computer apparatus, method, and non-transitory computer readable medium to signal real estate bubbles that help moderate and prepare CRE participants in advance of the adverse impacts of dramatic market swings. It may also be desirable to ensure that the big data sets used for such a prediction are distributed efficiently.

In view of the foregoing lack of credible, predictive CRE bubble indicators, disclosed herein are an apparatus, non-transitory computer readable medium, and method for predicting real estate bubbles based on big data analytics. In one aspect, an apparatus may comprise a memory device, a network interface and at least one processor. In another example, at least one processor may be configured to: communicate via the network interface with remote data sources containing historical variable data associated with real estate assets, the historical variable data being stored in a plurality of diverse data sets; distribute portions of the historical variable data via the network interface to a plurality of nodes on a network such that a size of a portion assigned to a respective node is in accordance with a real-time workload of the respective node, a total size of the historical variable data being larger than an available size in the memory device; receive historical real estate values from the plurality of nodes that are based at least partially on the distributed portions of the historical variable data; identify a plurality of previous peaks in the historical real estate values based at least partially on the historical real estate values received from the plurality of nodes; generate a prediction of a future peak in real estate values based at least partially on the plurality of previous peaks; and transmit an alert comprising the prediction.

In another example, a method is disclosed. The method may comprise: communicating, by at least one processor, with remote data sources containing historical variable data associated with real estate assets, the historical variable data being stored in a plurality of diverse data sets; distributing, by the at least one processor, portions of the historical variable data via the network interface to a plurality nodes on a network such that a size of a portion assigned to a respective node is in accordance with a real-time workload of the respective node, a total size of the historical variable data being larger than an available size in a memory device coupled to the at least one processor; receiving, by the at least one processor, historical real estate values from the plurality of nodes that are based at least partially on the distributed portions of the historical variable data; identifying, by the at least one processor, a plurality of previous peaks in the historical real estate values based at least partially on the historical real estate values received from the plurality of nodes; generating, by the at least one processor, a prediction of a future peak in real estate values based at least partially on the plurality of previous peaks; and transmitting, by the at least one processor, an alert comprising the prediction.

The techniques disclosed herein may provide quality predictions of real estate bubbles by optimizing the use of the big data sets used to generate such predictions. Specific data sources are distributed amongst nodes based on the current real-time workload of each node. The aspects, features and advantages of the present disclosure will be appreciated when considered with reference to the following description of examples and accompanying figures. The following description does not limit the application; rather, the scope of the disclosure is defined by the appended claims and equivalents.

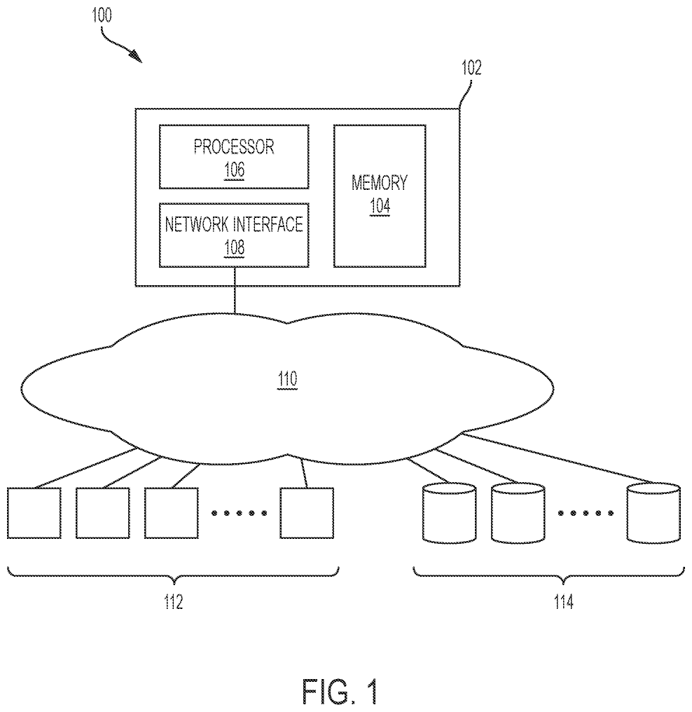

FIG. 1 presents a schematic diagram of an illustrative system 100 for predicting real estate bubbles based on big data. The system may include a computer apparatus 102 that is networked with a plurality of nodes and a plurality of big data sources. Computer apparatus 102 may comprise any device capable of processing instructions and transmitting data to and from other computers, including a laptop, a full-sized personal computer, a high-end server, or a network computer lacking local storage capability. Computer apparatus 102 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 102 may also comprise a network interface 108 to communicate with other devices over a network. Although all the components of computer apparatus 102 are functionally illustrated as being within the same block, it will be understood that the components may or may not be stored within the same physical housing.

The computer apparatus 102 may also contain at least one processor 106, which may be any type of processor, such as processors from Intel® Corporation. In another example, processor 106 may be an application specific integrated circuit (“ASIC”). Memory 104 may store instructions that may be retrieved and executed by processor 106 to carry out the techniques discussed herein. The instructions residing in memory 104 may comprise any set of instructions to be executed directly (such as machine code) or indirectly (such as scripts) by processor 106. In this regard, the terms “instructions,” “scripts,” or “modules” may be used interchangeably herein. The computer executable instructions may be stored in any computer language, such as in object code or modules of source code (e.g., C, C++, Java, Visual Basic, etc.). Furthermore, it is understood that the instructions may be implemented in the form of hardware, software, or a combination of hardware and software and that the examples herein are merely illustrative.

In one example, memory 104 may be used by or in connection with any instruction execution system that can fetch or obtain the logic from memory 104 and execute the instructions. In one example, memory 104 may include a random-access-memory device (“RAM”) or may be divided into multiple memory segments organized as dual in-line memory modules (“DIMMs”). In a further example, memory 104 may include non-transitory computer readable media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 102 directly or indirectly. The memory 104 may also include any combination of one or more of the foregoing and/or other devices as well. While only one processor and one non-transitory CRM are shown in FIG. 1, computer apparatus 102 may actually comprise additional processors and memories that may or may not be stored within the same physical housing or location.

Computer apparatus 102 may also be networked with other computers via network interface 108 and network 110. Network 110 may be a local area network (“LAN”), wide area network (“WAN”), the Internet, etc. Network 110 and intervening nodes may also use various protocols including virtual private networks, local Ethernet networks, and private networks using communication protocols proprietary to one or more companies, cellular and wireless networks, HTTP, and various combinations of the foregoing. Although only a few computers are depicted in FIG. 1 it should be appreciated that a network may include additional interconnected computers.

Each node 112 may also comprise a computer apparatus with a respective memory, processor, and network interface. The specifications of each node may be similar to that of computer apparatus 102. Alternatively, one or more nodes may have a unique specification. For example, a given node may have a different type of processor, memory, network interface, or operating system. As such, each node may only be capable of handling a certain workload. As discussed further below, this workload may be considered when the big data inputs are distributed amongst the nodes.

Data sources 114 may comprise historical variable data associated with CRE real estate assets. The historical data may include fairly recent data (e.g., 6 months) and data spanning decades (e.g., 30 or 40 years). In one example, the historical variable data in data sources 114 are preferably relevant for predicting commercial real estate downturns. In a further example, the data sources preferably have enough history to make a quality prediction. As noted above, the amount of historical data needed to provide an accurate real estate market prediction may be extremely vast. That is, the historical variable data may be vast enough to identify patterns but may be too vast for one computer apparatus to store and analyze. In one example, the total size of the historical variable data in data sources 114 may exceed the size of available space in memory 104.

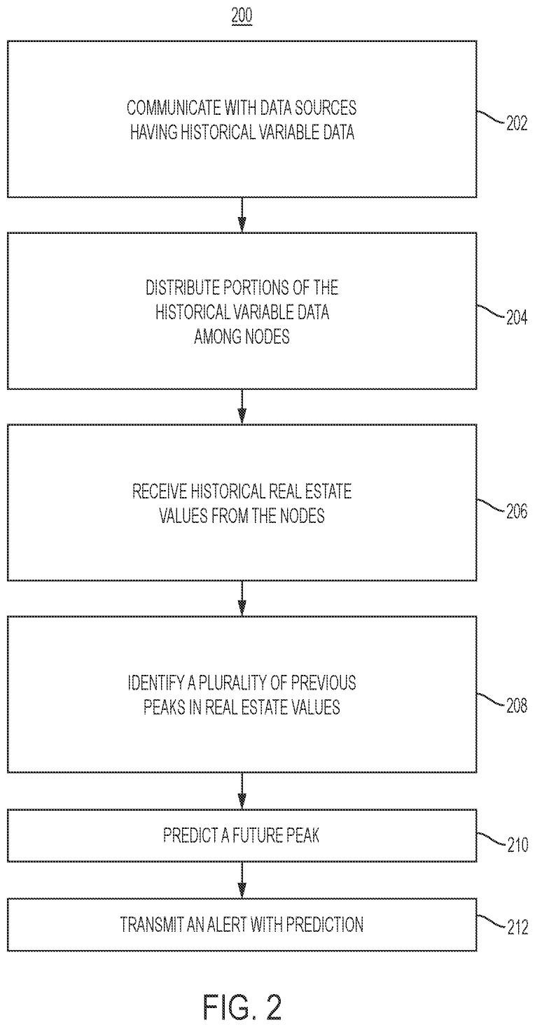

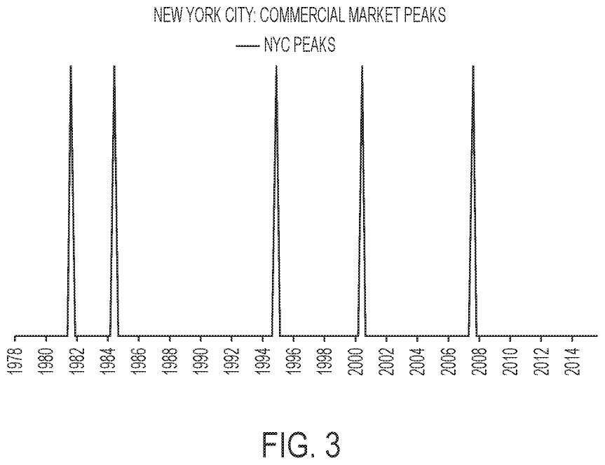

Working examples of the system, method, and non-transitory computer readable medium are shown in FIGS. 2-6. In particular, FIG. 2 illustrates a flow diagram of an example method 200 for predicting commercial real estate bubbles. FIGS. 3-6 show a working example in accordance with the techniques disclosed herein. The actions shown in FIGS. 3-6 will be discussed below with regard to the flow diagram of FIG. 2.

In block 202 of FIG. 2, processor 106 may communicate with remote data sources containing historical variable data associated with real estate assets. The historical variable data may be stored in a plurality of diverse data sets, such as structured or unstructured data. As noted above, the amount of historical variable data for making a quality real estate bubble prediction may include extremely large data sets (e.g., several terabytes or exabytes) containing billions to trillions of records. Below is a list of historical variable data that may be employed to predict commercial real estate bubbles. However, it is understood that the historical variable data indicated below is illustrative and that more or fewer variables may be considered. It is also understood that the data sources indicated below are illustrative and that the data may be obtained from alternate data sources:

Change in CPI or Median Consumer Price Index. The CPI data may be obtained by communicating with a Federal Reserve Economic database (“FRED”). On example of such database is the MEDCPIM157SFRBCLE database maintained by the Federal Reserve Bank of Cleveland.

Change in 10 year bond yield: In one example, this data may be obtained from FRED database DGS10 held by the Federal Reserve Bank of St. Louis.

2 year constant maturity yields: In one example, this data may be obtained from FRED database DGS2 held by the Federal Reserve Bank of St. Louis.

Consumer confidence: This data may be obtained from surveys of consumers, such as survey databases maintained at the University of Michigan

Implied Net Operating Income Growth (“NOI”): This data may be obtained from historical U.S. Real Estate Investment Trust (“REIT”) data sources. In one example, REITs are utilized as a proxy for the overall valuation dynamics in commercial real estate. Starting from a model for risk premium, or expected excess returns on REITS, a dynamic five factor model may be estimated with stock, bond, value, size and momentum returns as factors. The factor risk exposures (betas) may be re-estimated each month based on rolling 60-month windows to obtain the risk premium. These betas may be multiplied by the average factor return over the full sample. Again, in one example it is preferable to use as much data as possible, since average factor risk premium is difficult to identify. With the time-series of the expected excess on real estate, processor 106 may add a one month nominal interest rate to arrive at the expected return on real estate, or cost of capital. With this time series of expected returns and with the time series of observed price-dividend ratios (inverse cap rates), processor 106 may render a prompt requesting expectations of future dividend NOI growth, using the present-value model due to Campbell and Shiller (1989). At each point, it may be assumed that NOI growth will be at its long-term average after year 10. What the market perception of dividend (NOI) growth must be over the next 10 years is backed out, expressed as an annual growth rate, in order to justify the current cap rate, and given the current expected return from the five-factor model described above.

Change in employment: This data may be obtained from the Bureau of Labor Statistics.

If a local market perspective is required, processor 106 may communicate with different data sources. For example, processor 106 may obtain local appraisal based cap rates and national appraisal based cap rates from the National Council of Real Estate Investment Fiduciaries (“NCREIF”). This data may be obtained in lieu of change in CPI, consumer confidence, NOI, and change in employment.

Referring back to FIG. 2, processor 106 may distribute portions of the historical variable data amongst nodes 112 over network 110, as shown in block 204. As noted above, the total size of the historical variable data stored in data sources 114 may be greater than the available size in memory 104 of computer apparatus 102. As such, in one example, the data may be partitioned into independent portions and distributed among nodes 112. The size of each assigned portion may be in accordance with the real-time workload of the respective node. Computer apparatus 102 may communicate with a given node to determine the real-time workload thereof. A given node may provide computer apparatus 102 with information indicative of its current available memory and a number of processors at its disposal. Based on the workload information, computer apparatus 102 may calculate a portion size accordingly.

The nodes 112 may process their respective portions in parallel and communicate their respective output back to computer apparatus 102. In one example, a map reduce algorithm may be employed to schedule the processing across the nodes, monitor the nodes, and re-execute any failures of a given node. Each portion may represent a certain time period in the historical variable data. For example, one node may be apportioned historical variable data between 1970 through 1974; another node may be apportioned historical variable data between 1975 through 1978, and so on. Processor 106 may assign the time periods based on a size of the data covering a respective time period and the real-time workload of each node. As noted above, based on the workload data received from each node, processor 106 may apportion the historical variable data accordingly.

In block 206 of FIG. 2, processor 106 may receive intermediate results from each node 112 in the form of historical real estate values. These results may be based at least partially on the distributed portions of the historical variable data. Therefore, each node may calculate historical real estate values that cover a respective time period. As noted above, the real estate values may include cap rates. The cap rates may be estimated based on the data sources discussed above.

Referring back to FIG. 2, processor 106 may identify a plurality of previous peaks in the historical real estate values based at least partially on the historical real estate values received from the plurality of nodes, as shown in block 208. In one example, a “peak” may be defined as the start of a major downturn in real estate values. In a further example, when processor 106 identifies a twenty percent increase over two years in cap rate spreads vs. ten year treasuries, the previous low point is tagged as a peak.

Taking the estimated commercial transaction cap rates discussed above, processor 106 may subtract ten year U.S. treasury yields. The resulting value may be referred to as cap rate spreads, which may be used to understand the risk and return expectations of commercial real estate. This adjusts for the long run decrease in commercial cap rates, largely co-incident with a similar reduction in treasury yields. In another example, processor 106 may identify a peak by first identifying “damage periods.” A damage period may be defined as a point where commercial cap rate spreads increase more than 20% percent from minimum values over two years. Because the data may be adjusted upwards to remove the negative cap rate spreads that occur due to high inflation, processor 106 may identify 6% drops in this transformed series, which is equivalent to 20% drops in the original. Processor 106 may then identify the last period with a drawdown value of zero as a peak.

FIG. 3 is a working example of peak identification for the New York City market, with a spike representing a peak. This shows that the results are largely unaffected by the choice of lag period. Peaks are identified in 1981, 1984, 1994, 2000 and 2007. This largely agrees with market practitioners' experience of market peaks. The only notable exception is the Savings and Loan crisis in the late 80's. This crisis occurred within the overall context of a booming market, and thus our drawdown calculation never finds a peak. The methodology can be extended to use the calculated market risk premium for commercial assets, which will provide a better theoretical backing than cap rate spreads. The instructions executed by processor 106 may be further refined. For example, inflation and trends within the commercial cap rate spreads can be dealt with by replacing spreads with calculated risk premium from a Campbell Shiller decomposition. For the model, the current tagging process accomplishes most of the goals.

Referring now to block 210 of FIG. 2, processor 106 may generate a prediction of a future peak in real estate values based at least partially on the plurality of previous peaks discussed above. In one example, processor 106 determines a probability distribution for the time of a future event:

P(t) (equation 1)

where t is the first occurrence of the event. This permits computer apparatus 102 to determine the chance of the event occurring in the next T periods, which is equivalent to:

P(t≤T) (equation 2)

In one example, at each period, processor 106 produces a distribution of the probability of events (e.g., peaks) at future periods. This distribution may be the distribution of future event times, conditional on the data and the event not having happened yet. One example form for this distribution is the exponential distribution:

P(k)=λₜe^{-λ}^{ₜ}^{(k)} (equation 3)

where λₜ is the rate of the event. This model makes the assumption that the rate of the event is constant in all future periods. In another example, this assumption may be relaxed by using a Weibull distribution instead. In order to determine the current rate of the event given the data that has been observed, processor 106 may start with the form suggested by Cox 1972 to make the current rate of the event dependent on the observed data.

λₜ=λ₀e^{βX}^{ₜ} (equation 4)

where β is a vector of covariates and Xₜ is a vector of data at time t. Processor 106 may then modify the model of equation 4 to account for specific issues of importance in predicting downturns. It has been noted that factors that lead to overvaluation are often long term states. It would be inappropriate for the model to change vastly from period to period, as only a small amount of relevant economic information is revealed in each period. Thus processor 106 may modify equation 4 as follows:

λₜ=λ₀e^{Σ}^{ₛ₌₀}^{^{t}}^{_{βX}}^{_{S}}^{+β} (equation 5) where α is a constant.

Hence, a final form of our model may be expressed as equation 3 where λₜ of equation 3 is expressed as equation 5. The model may be referred to herein as the “hybrid model”. According to such hybrid model, β is a vector of covariates and Xₜ is a vector of data at time t, β and Xₜ being vectors of the same size. Each entry of the vector Xₜ at a given time t may include a respective data value (at time t) for each of the following variables or indicators: (i) Change in CPI, (ii) Change in 10 year bond yield, (iii) Consumer confidence, (iv) Implied NOI growth, and (v) Change in employment, as discussed herein, although fewer, additional, and/or other variables or indicators may be used. β, α, and λ₀ are further discussed below.

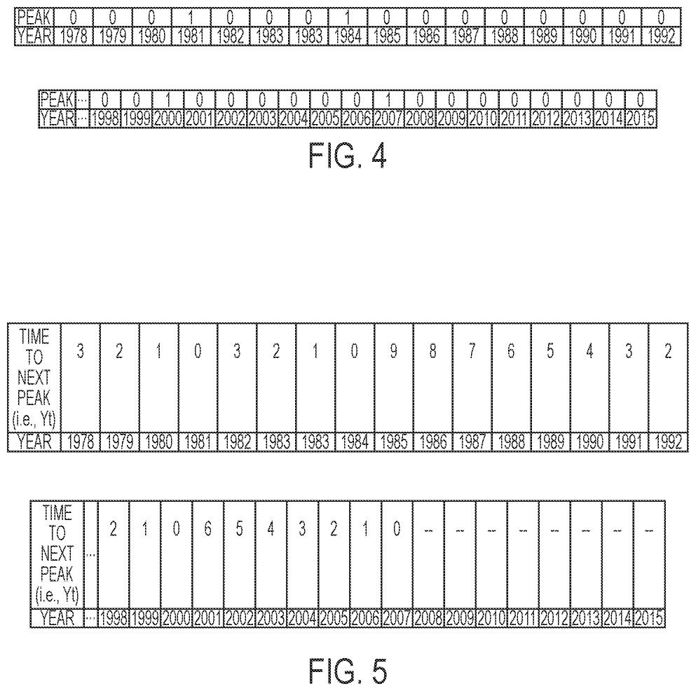

Using New York City as an example market, based on historical data a first step may be to determine commercial market peaks (i.e., peak tagging) in that market, as shown in FIG. 3. As noted above, FIG. 3 shows New York City peaks for the years 1981, 1984, 1994, 2000, and 2007. Next, processor 106 may represent each year or period as a 1 if a peak occurred in that year and as a 0 if no peak occurred in that year, as shown in FIG. 4. Note that according to this example, years are being used as the time period for the model. The example hybrid model/system nonetheless could be expressed in shorter periods of time (e.g., quarters, half years) or longer periods of time. Thereafter, for each year (period), the time (in this example, the number of years) until the next peak may be determined, as shown in FIG. 5. FIG. 5 shows calculations based on FIG. 4. In the example of FIG. 5, a “3” is entered for 1978, which represents 3 years until the next peak (i.e., 1981), a “2” is entered for 1979, which represents 2 years until the next peak (i.e., 1981), etc. Note that years 2008-2015 are blank in that it is not known when the next peak will occur. This time to peak data, as shown in FIG. 5, may be referred to as yₜ for each period/time (i.e., yₜ=3 for 1978, yₜ=2 for 1979, etc.)

Next, using the model of equations 3 and 5, for each year (in this example, 1978-2007) (although a subset of these years may also be used) the probability of a peak occurring in the next yₜ periods/years may be computed where t is set to yₜ for that year. In other words:

P(t=yₜ)=λₜe^{-λ}^{ₜ}^{(y}^{ₜ}⁾ (equation 6)

$$P ( t = {y}_{t} ) = {λ}_{t} {e}^{- {λ}_{t} ( {y}_{t} )} \qquad ( equation 6 )$$

$${λ}_{t} ( t = {y}_{t} ) = {λ}_{0} {e}^{{\sum }_{s = 0}^{{y}_{t}} β {X}_{s} + α} \qquad ( equation 7 )$$

For each computation, the same vector β and constant α and constant λ₀ may be used. Initially, for these computations, vector β and constant α and constant λ₀ may be initialized to any value(s) (such as 1). Regarding Xs, as indicated this is a vector of data values for the above noted indicators, for example, with the values for each indicator based on, for example, data corresponding to the respective year/period. In this example, the data itself may pertain to the New York City market as appropriate. Once each probability is computed, the likelihood of the entire dataset may be determined as the product of these probabilities:

L(Y)=Πₜ₌₀^{T}P(t=yₜ) (equation 8)

Thereafter, the likelihood L(Y) may be maximized with respect to β and α and λ₀. In other words, the values of β and α and λ₀ may be adjusted and each of the above noted probabilities recomputed based on the modified values of β and α and λ₀. Thereafter, L(Y) may be recomputed. The process of adjusting the values of β and α and λ₀ and re-computing L (Y) may be iteratively continued until L (Y) obtains a maximum value. Alternatively, the computations may be done for a set number of iterations. As another example, the computations may be done until L(Y) obtains and/or exceeds a defined threshold value. One will recognize that other examples are possible. In general, this maximization may be done using, for example, non-linear optimization. In order to avoid spurious correlation, all indicator variables may be differenced until stationary.

This process of determining values of β and α and λ₀ may be viewed as a training process to train computer apparatus 102 for a given market. Hence, once “final” values of β and α and λ₀ are determined, they may be “inserted” into equations 3 and 5 to obtain a “final form” of the hybrid model of downturn probabilities.

This “final form” of the model may then be used to look forward from the present date/time and determine the probability of a peak occurring at some set time in the future. For example, setting t to some value “A” (where A is some desired number of years in the future such as ¼ year, ½ year, 1 year, 2 years, 5 years, etc.) and setting the vector of data values Xs to values based on, for example, data corresponding to the present time (e.g., values based on the most recently available data), the probability of a peak occurring (in this example, New York City) in the next “A” years may be determined. Various values of “A” may be used to determine the respective probability of a peak occurring within that number of years.

One will recognize that models as described above may be determined for various respective markets using as appropriate data corresponding to that market. One will also recognize that the hybrid model, once trained for a given market, may be retrained as additional peaks actually occur in that market, for example. One will also recognize that once values of β and α and λ₀ are determined for a final form of the model for a given market, these values may be used as the initial values when retraining the model for that market. As another example, once values of β and α and λ₀ for a given market are determined, these values may be used as the initial values for β and α and λ₀ when training the model for a different market. Other examples are possible.

One will recognize that computer apparatus 102 may be used to train and execute the model described herein. For example, computer apparatus 102 may interface via a communications network with data sources 114 and obtain data for determining peaks (peak tagging) and for populating the vector Xs. Data may be gathered for multiple markets. In conjunction with nodes 112, computer apparatus 102 may determine peaks and also train a model as discussed herein for each respective market. Thereafter, a given model for market may be used to determine one or more probabilities of peaks occurring over a set of years, for example.

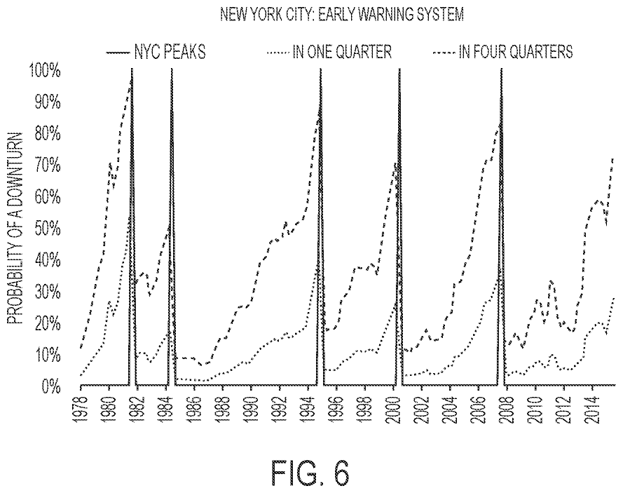

Referring back to FIG. 2, processor 106 may transmit an alert comprising a prediction, as shown in block 212. These probabilities may be displayed on display devices, including remote computing devices (such as user phones, computers, kiosks etc.) that are communicated with via a communications network. By way of example, a given user (using a computing device) may communicate with the servers and specify a given market and one or more future time periods over which the user would like to know the probability of a peak occurring. Computer apparatus 102 may compute these probabilities and communicate the results back to the user for display on the user device. One will recognize other examples are possible. The alert may also be displayed as a graph. FIG. 6 shows a working example of results for the New York City market. The solid lines are observed peaks in the real estate market, the dotted line is the probability that a peak will occur in the next quarter, and the dashed line is the probability that a peak will occur in the next four quarters. For example, the 2007 downturn is predicted with startling accuracy. In 2004, the chart of FIG. 6 illustrates that there is about a 5% probability of a downturn in the next month and over a 20% chance in the next four quarters.

One of the benefits of the system disclosed herein is that it may recognize that different investors have different horizons of concern. Computer apparatus 102 may give the downturn probability for any desired future interval and help investors with different risk appetites make decisions accordingly. Investors looking for information about the next 1 year, 2 years or even 10 years can all be satisfied. Edge cases are also handled in the appropriate way (e.g., the probability of a downturn in the next 20 years is ˜100%).

Advantageously, the above-described computer apparatus, non-transitory computer readable medium, and method may provide quality predictions of real estate bubbles or downturns in a given market. The computer apparatus may determine how to distribute extremely large structured and unstructured data sets across a network of computers for parallel processing. These data sets may contain historical variable data associated with real estate assets. In turn, the system may generate a real estate bubble prediction based on the vast amounts of historical data. Such predictions may be used to make wise real estate investment decisions.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, various steps can be handled in a different order or simultaneously, and steps may be omitted or added.

What is claimed is:

1. An apparatus comprising:
a memory device;
a network interface;
at least one processor to:
communicate via the network interface with remote data sources containing historical variable data associated with real estate assets, the historical variable data being stored in a plurality of diverse data sets;
distribute portions of the historical variable data via the network interface to a plurality of nodes on a network such that a size of a portion assigned to a respective node is in accordance with a real-time workload of the respective node, a total size of the historical variable data being larger than an available size in the memory device;
receive historical real estate values from the plurality of nodes that are based at least partially on the distributed portions of the historical variable data;
identify a plurality of previous peaks in the historical real estate values based at least partially on the historical real estate values received from the plurality of nodes;
generate a prediction of a future peak in real estate values based at least partially on the plurality of previous peaks; and
transmit an alert comprising the prediction.
